(19) United States
(12) Patent Application Publication
(10) Pub. No.: US 2025/0037258 A1
(43) Pub. Date: Jan. 30, 2025

(54) METHOD FOR DETERMINING A PARAMETER OF A CLOSURE, PRIVACY OR SUN PROTECTION APPARATUS

(71) Applicant: SOMFY ACTIVITES SA, Cluses (FR)

(72) Inventors: Fabien Rousseau, Mieussy (FR); Pierre Geriniere, Cluses (FR); Liesbet Hervieu-Besson, Evires (FR); Eric Sermet-Magdelain, Sallanches (FR)

(73) Assignee: SOMFY ACTIVITES SA, Cluses (FR)

(21) Appl. No.: 18/716,693

(22) PCT Filed: Dec. 8, 2022
(86) PCT No.: PCT/EP2022/085038

§ 371 Date: Jun. 5, 2024

(30) Foreign Application Priority Data
Dec. 8, 2021 (FR) FR2113139

(51) Int. Cl. G06T 7/00; E06B 9/24; G05B 13/02; G06T 7/70

(52) U.S. Cl. CPC G06T 7/0002; G05B 13/024; G06T 7/70; E06B 9/24

(57) ABSTRACT

The method for determining at least one parameter of an apparatus (100) including a closure, privacy or sun protection screen (2) is at least partially implemented by a tool for configuring the apparatus, and includes at least (E10) obtaining a first set (E1) of adjustable parameters for defining the apparatus, including at least one parameter related to the geometry of the screen in the apparatus; (E20) obtaining a second set (E2) of fixed parameters for defining the apparatus; (E60) calculating the shade produced by the screen of the apparatus at at least one moment in time provided by a timestamp, the screen being considered to be in an at least partially deployed position; and (E70) using (E70) the calculated shade in defining the value of at least one first parameter of the first set.

The present invention relates to a method for determining at least one parameter of a closure, privacy or solar protection installation. The invention relates also to a configuration method implementing such a determination method. The invention relates also to an installation or a control unit obtained by the implementation of the determination method. The invention relates also to a determination device implementing such a method.

Generally, the present invention relates to the field of home automation installations comprising privacy devices including a motorized driving device setting a screen in motion, between at least one first position and at least one second position.

A motorized driving device comprises an electromechanical actuator of a movable closure, privacy or solar protection element, such as a shutter, a gate, a grating, a blind or any other equivalent piece of equipment, hereinafter called screen. In particular, the screen can be a slatted screen or screen with slats or, preferably, a screen comprising a fabric.

One recurrent problem in the field of home automation relates to the correct definition of a home automation installation (for example the geometrical characteristics of the installation) and/or the correct configuration of a home automation installation (for example the saving of particular states or configurations of the installation) in order to best ensure functions that make it possible to meet the needs of the users.

The aim of the present invention is to resolve the above-mentioned drawbacks and to propose a method for determining at least one parameter of a closure, privacy or solar protection installation in order to optimize a home automation installation in terms of functionality provided to the users.

According to the invention, the method makes it possible to determine at least one parameter of an installation comprising a closure, privacy or solar protection screen. The method is at least partially implemented by a configuration tool of the installation. The method comprises at least the following steps:
a. a step of obtaining a first set of adaptative parameters for defining the installation,
b. a step of obtaining a second set of fixed parameters defining the installation,
c. a step of calculating a shadow produced by the screen of the installation at at least one moment given by a timestamp, the screen being considered in a position of at least partial deployment,
d. a step of using the calculated shadow in defining the value of at least one first parameter of the first set.

Preferably, the first set (E1) of adaptative parameters for defining the installation comprises at least one parameter associated with the geometry of the screen in the installation.

Preferably, the geometrical characteristics of the shadow produced by the screen of the installation are calculated at at least one moment given by a timestamp, the screen being considered in a position of at least partial deployment, on the basis of the at least one parameter of the first set associated with the geometry of the screen in the installation.

The method can comprise:
a step e. of memorizing the value of the at least one first parameter of the first set defined in the step d., and
one or more successive iterations of a step of modifying a value of the at least one first parameter of the first set of parameters and of the step c., the method possibly then comprising a step f. of choosing from among several values of the at least one first parameter of the first set.

The method can comprise:
a step e. of memorizing the value of the at least one first parameter defined in the step d., and
one or more successive iterations of a step of modifying a value of at least one second parameter of the first set of parameters, different from the first parameter, and of the step c.

The method can comprise:
g. a step of modifying a characteristic of the shadow calculated in the step d. and, as a consequence of this modification,
h. a step of determining a modified value of the at least one first parameter, notably a modified value of the at least one parameter making it possible to obtain the modified characteristic of the shadow.

The step g. of modifying the calculated shadow characteristic can comprise:
g1. a step of displaying the calculated shadow as an image on an interface of the configuration tool,
g2. a step of pointing to a zone on the image displaying the shadow, and
g3. a step of modifying the status of the shadow in the zone being pointed to.

The installation can be a motorized installation and:
the first set of adaptative parameters for defining the installation, and/or
the second set of fixed parameters for defining the installation, and/or
the value of the at least one first parameter defined during the step of use of the calculated shadow, can be transmitted from the configuration tool to a control unit of the installation.

The method can comprise a step of obtaining a solar mask at the location of the installation, the step of obtaining the solar mask comprising:
a step of producing at least one photographic image (P) from the location and in a known direction, and
a step of processing the at least one photographic image.

The method can comprise:
iterations of at least the step c. for different timestamps, and
a step of calculating a radiation energy intercepted by the screen of the installation during a period defined by the different timestamps.

According to the invention, the method for configuring a home automation installation comprises:
a phase of implementing the determination method defined previously, and
a phase of taking into account the value of the at least one first parameter of the first set, defined in the preceding phase, notably a phase of producing and/or configuring the installation in accordance with the value of the at least one first parameter of the first set, defined in the preceding phase.

The configuration method can comprise a phase of creation of a control command dependent on the value of the at least one parameter defined in the step d. of the phase of implementation of the determination method.

According to the invention, an installation or a control unit is obtained by the implementation of the configuration method defined previously.

Other features and advantages of the invention will become more apparent from the following description referring to the attached drawings, given as nonlimiting examples:

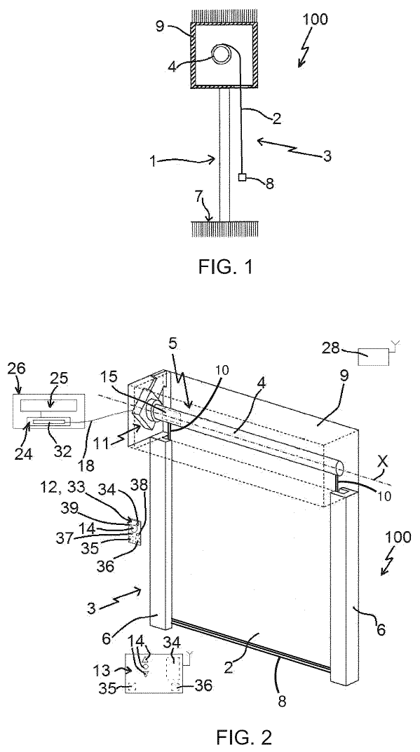

FIG. 1 is a schematic view in transverse cross-section of an installation in accordance with an embodiment of the invention;

FIG. 2 is a perspective schematic view of the installation illustrated in FIG. 1;

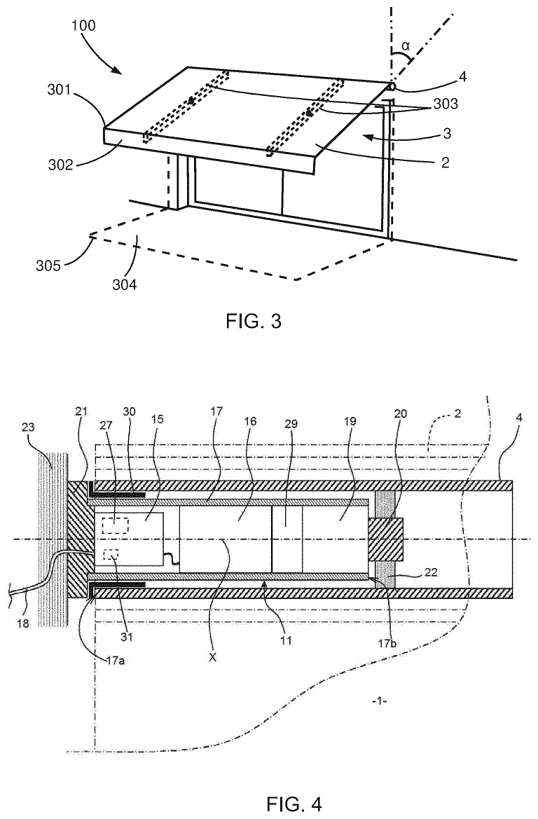

FIG. 3 is a perspective schematic view of another installation to which the invention can be applied;

FIG. 4 is a schematic and partial view in axial cross section of the installation illustrated in FIGS. 1 and 2 or 3, showing an electromechanical actuator of the installation;

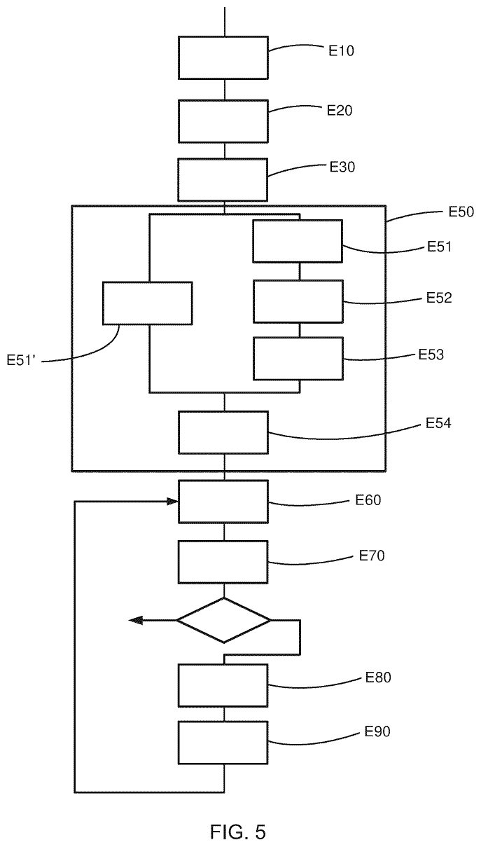

FIG. 5 is a block diagram of an algorithm of a mode of execution of a method according to the invention;

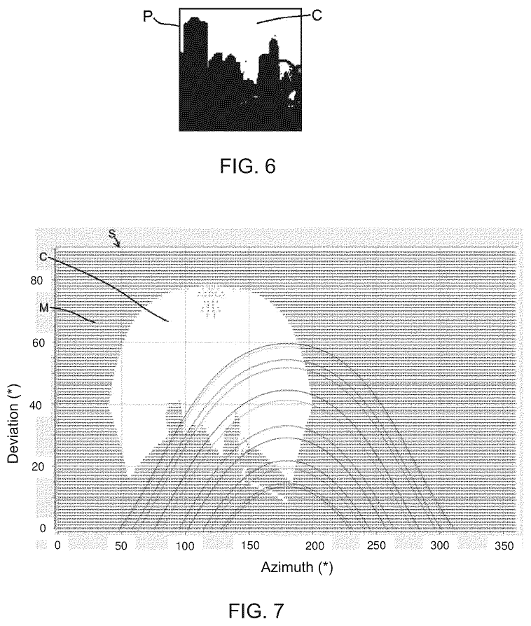

FIG. 6 is an example of result of an image processing of a photograph taken by means of a photographic appliance of a mobile terminal; and

FIG. 7 is an example of result of a superimposition of data of a photograph projected onto a solar path diagram.

First to be described, with reference to FIGS. 1 and 2, is a closure, privacy or solar protection installation 100 according to the invention and installed on the outside of a building, notably close to the building, in particular close to an opening of the building or at an opening of the building. The opening is for example a window or a door. The installation 100 comprises a privacy device 3, in particular a motorized blind equipped with a screen 2.

The privacy device 3 can be a blind with a screen 2 made of fabric or, possibly, with orientable slats. The present invention applies to all types of privacy device.

Here, the installation 100 comprises the privacy device 3. The privacy device 3 can be fixed to a structure of the building or to a structure ancillary to the building, for example to a structure of a pergola or a arbour.

Blinds forming part of embodiments of the invention are described with reference to FIGS. 1, 2 and 3.

The screen 2 of the privacy device 3 is wound on a winding tube 4 driven by a motorized driving device 5. The screen 2 is movable between a wound position, in particular high in the embodiment of FIGS. 1 and 2, and an unwound position, in particular low in the embodiment of FIGS. 1 and 2.

Here, the installation 100 comprises the motorized driving device 5.

The movable screen 2 of the privacy device 3 is a closure, privacy and/or solar protection screen that is wound on the winding tube 4 whose inner diameter is substantially greater than the outer diameter of an electromechanical actuator 11, such that the electromechanical actuator 11 can be inserted into the winding tube 4, during the assembly of the privacy device 3.

The motorized driving device 5 comprises the electromechanical actuator 11, in particular of tubular type, making it possible to rotate the winding tube 4, so as to displace, in particular unwind or wind up, the screen 2 of the privacy device 3.

The privacy device 3 comprises the winding tube 4 for folding up the screen 2. In the mounted state, the electromechanical actuator 11 is inserted into the winding tube 4.

The blind, which forms the privacy device 3, can comprise an apron comprising a flexible fabric, forming the screen 2 of the blind, the fabric being able to be wound on the winding tube 4 and possibly guided by two lateral runners 6. Alternatively to a screen composed of a fabric, the blind comprises horizontal slats, incorporated in a fabric or suspended by cords. The runners can be produced in uprights of a pergola structure and the screen can be disposed vertically or substantially vertically. As an alternative or in addition, the runners can be produced in stringers or cross-members of a pergola structure and the screen can be disposed horizontally or substantially horizontally.

The wound high position corresponds to the positioning of a load bar 8, of the apron 2 of the blind 3 at an edge of a box 9 of the privacy device 3 or to the stopping of the load bar 8 in a programmed high end-of-travel position. Furthermore, the unwound low position corresponds to the bearing of the load bar 8 of the apron 2 of the blind 3 on a sill 7 or to the stopping of the load bar 8 in a programmed low end-of-travel position.

Here, the screen 2 is configured to be displaced, by means of the motorized driving device 5, between an open position, corresponding to the wound position that can also be called high end-of-travel position FdcH, and a closed position, corresponding to the unwound position and that can also be called low end-of-travel position FdcB.

In the case of a slatted blind, the various slats of the blind are preferably suspended via chords intended to be wound onto a winding tube or unwound from the winding tube so as to fold up or deploy the screen.

In the case of a blind 3 having a screen made of fabric 2, the screen is directly wound onto or unwound from the winding tube 4 so as to fold up or deploy the blind.

The winding tube 4 is disposed inside the box 9 of the blind 3. The apron 2 of the blind 3 is wound and unwound around the winding tube 4 and is housed at least partly inside the box 9.

Generally, the box 9 is fixed onto the structure, for example at an opening of the structure.

There now follows a more detailed description, with reference to FIG. 3, of an embodiment of a privacy or solar protection installation 100 according to the invention and installed on the outside of a building, notably on the building, in particular close to an opening of the building or at an opening of the building. The installation comprises a motorized awning blind 3. The blind comprises a screen 2 composed of a fabric. The screen is held taut between a load bar 301 and a winding tube 4 by the mechanical action of foldable arms 303 on the load bar. The installation is configured such that the screen is deployed in a plane forming an angle α with the vertical. The blind preferably has a valance 302 formed for example by a part of fabric extending vertically.

Such an awning blind notably has at least some of the following parameters:
a screen type,
a screen length,
a screen width,
an orientation of the screen relative to a vertical (angle α),
a length of projection, in a vertical direction, of the screen onto a horizontal surface,
a valance height,
a position or location of the installation relative to the structure of the building,
an orientation of the screen relative to the cardinal points.

Whatever the embodiment, the motorized driving device 5 is controlled by a control unit. The control unit can be, for example, a local control unit 12.

The local control unit 12 can be linked by a wired or wireless link with a central control unit 13. The central control unit 13 drives the local control unit 12, and other local control units that are similar and distributed in the building.

The motorized driving device 5 is, preferably, configured to execute the commands of displacement, notably of deployment or of folding up, of the screen 2 of the privacy device 3, that can be transmitted, notably, by the local control unit 12 or the central control unit 13.

The installation 100 comprises either the local control unit 12, or the central control unit 13, or the local control unit 12 and the central control unit 13.

There now follows a more detailed description, with reference to FIG. 4, of the motorized driving device 5, including the electromechanical actuator 11, belonging to the installation 100 of FIG. 1, 2 or 3.

Advantageously, the electromechanical actuator 11 comprises an electric motor 16. The electric motor 16 comprises a rotor and a stator, not represented and positioned coaxially about an axis of rotation X, which is also the axis of rotation of the winding tube 4 in the mounted configuration of the motorized driving device 5.

Control means of the electromechanical actuator 11, allowing the displacement of the screen 2 of the privacy device 3, are composed of at least one electronic control unit 15. This electronic control unit 15 is capable of starting up the electric motor 16 of the electromechanical actuator 11, and, in particular, allowing the supply of electrical energy to the electric motor 16.

Thus, the electronic control unit 15 controls, notably, the electric motor 16, so as to open or close the screen 2, as described previously.

The control means of the electromechanical actuator 11 comprise hardware and/or software means.

As a nonlimiting example, the hardware means can comprise at least one microcontroller 31.

The electronic control unit 15 comprises at least one first communication module 27, in particular for receiving control commands, the control commands being transmitted by a command transmitter, such as the local control unit 12 or the central control unit 13, these commands being intended to control the motorized driving device 5.

Preferentially, the first communication module 27 of the electronic control unit 15 is of wireless type. In particular, the first communication module 27 is configured to receive radiofrequency control commands.

Advantageously, the first communication module 27 can also allow the reception of control commands transmitted by wired means.

The electronic control unit 15, the local control unit 12 and/or the central control unit 13 can be in communication with a weather station, not represented, remotely sited outside of the building, including, notably, one or more sensors that can be configured to determine, for example, a temperature, a brightness or even a wind speed.

The electronic control unit 15, the local control unit 12 and/or the central control unit 13 can also be in communication with a server 28, so as to control the electromechanical actuator 11 according to data made available remotely via a communication network, in particular an Internet network that can be linked to the server 28.

The electronic control unit 15 can be controlled from the local 12 or central 13 control unit. The local 12 or central 13 control unit is provided with a control keypad. The control keypad of the local 12 or central 13 control unit comprises one or more selection elements 14 and, possibly, one or more display elements 34.

As nonlimiting examples, the selection elements can comprise pushbuttons and/or sensitive keys. The display elements can comprise light-emitting diodes and/or an LCD (acronym for “Liquid Crystal Display”) or TFT (acronym for “Thin Film Transistor”) display. The selection and display elements can also be produced by means of a touch screen.

The local 12 or central 13 control unit comprises at least one second communication module 36.

Thus, the second communication module 36 of the local 12 or central 13 control unit is configured to transmit, in other words transmits, control commands, in particular by wireless means, for example radiofrequency, or by wired means.

Furthermore, the second communication module 36 of the local 12 or central 13 control unit can also be configured to receive, in other words receives, control commands, in particular via the same means.

The second communication module 36 of the local 12 or central 13 control unit is configured to communicate, in other words communicates, with the first communication module 27 of the electronic control unit 15.

Thus, the second communication module 36 of the local 12 or central 13 control unit exchanges control commands with the first communication module 27 of the electronic control unit 15, either monodirectionally or bidirectionally.

Advantageously, the local control unit 12 is a control point, that can be fixed or mobile. A fixed control point can be a control housing intended to be fixed onto a facade of a wall of the building or onto a face of a frame housing a window or a door. A mobile control point can be a remote control, a smart phone or a tablet.

Advantageously, the local 12 or central 13 control unit also comprises a controller 35.

The motorized driving device 5, in particular the electronic control unit 15, is, preferably, configured to execute control commands of displacement, notably of closure and of opening, of the screen 2 of the privacy device 3. These control commands can be transmitted, notably, by the local control unit 12 or by the central control unit 13.

The motorized driving device 5 can be controlled by the user, for example by the reception of a control command corresponding to a press on the or one of the selection elements 14 of the local 12 or central 13 control unit.

The motorized driving device 5 can also be controlled automatically, for example by the reception of a control command corresponding to at least one signal originating from at least one sensor and/or to a signal originating from a clock of the electronic control unit 15, in particular of the microcontroller 31. The sensor and/or the clock can be incorporated in the local control unit 12 or in the central control unit 13.

The motorized driving device 5 comprises an autonomous electrical energy supply device 26.

The autonomous electrical energy supply device 26 comprises at least one photovoltaic panel 25 and at least one electrical energy storage device 24.

The autonomous electrical energy supply device 26 is configured to supply electrical energy to the electromechanical actuator 11.

Thus, the autonomous electrical energy supply device 26 makes it possible to supply electrical energy to the electromechanical actuator 11, without being itself linked electrically to a mains electrical power supply network.

Here, the photovoltaic panel 25 is linked electrically to the electrical energy storage device 24.

The electromechanical actuator 11 is linked electrically to the autonomous electrical energy supply device 26 and, more particularly, to the electrical energy storage device 24. Preferably, the electromechanical actuator 11 is linked electrically to the autonomous electrical energy supply device 26 and, more particularly, to the electrical energy storage device 24 by means of at least one electrical power supply cable 18, so as to allow the supply of electrical energy to the electromechanical actuator 11 from the autonomous electrical energy supply device 26.

The electronic control unit 15 is linked electrically to the autonomous electrical energy supply device 26 and, more particularly, to the battery electrical energy storage device 24.

Advantageously, the electrical energy storage device 24 comprises at least one battery 32.

Advantageously, the battery 32 comprises at least one electrical energy storage element, not represented.

Here, the battery 32 comprises a plurality of electrical energy storage elements. Preferentially, the electrical energy storage elements are linked electrically in series.

The number of electrical energy storage elements of the battery is nonlimiting.

Advantageously, the electrical energy storage device 24 is of rechargeable type and is configured to supply electrical energy to the electromechanical actuator 11. Furthermore, the electrical energy storage device 24 is configured to be supplied with electrical energy by the photovoltaic panel 25.

Thus, the recharging of the electrical energy storage device 24 is implemented by solar energy, by means of the photovoltaic panel 25.

In this way, the electrical energy storage device 24 can be recharged without having to remove a part of the box 9 of the privacy device 3.

The photovoltaic panel 25 comprises at least one photovoltaic cell and, more particularly, a plurality of photovoltaic cells.

The motorized driving device 5, in particular the photovoltaic panel 25, comprises charging elements configured to charge the battery 32 of the electrical energy storage device 24 from the solar energy collected by the photovoltaic panel 25.

Thus, the charging elements configured to charge the battery 32 of the electrical energy storage device 24 from the solar energy make it possible to convert the solar energy collected by the photovoltaic panel 25 into electrical energy.

As a variant or in addition, the motorized driving device 5, in particular the electromechanical actuator 11, is supplied with electrical energy by means of the battery 32 or from a mains electrical power supply network, in particular by the commercial AC network, notably as a function of a state of charge of the battery 32.

A casing 17 of the electromechanical actuator 11 is, preferentially, of cylindrical form.

In one embodiment, the casing 17 is produced in a metallic material.

The material of the casing of the electromechanical actuator is nonlimiting and can be different. It can be, in particular, a plastic material.

Advantageously, the electromechanical actuator 11 also comprises a reducer 19, a brake 29 and an output shaft 20.

Advantageously, the reducer 19 comprises at least one reduction stage. The reduction stage can be a gear train of planetary type.

The type and the number of reduction stages of the reducer are nonlimiting. The number of reduction stages can be greater than or equal to two.

As a nonlimiting example, the brake 29 can be a spring brake, a cam brake or an electromagnetic brake.

The electromechanical actuator 11 can also comprise an end-of-travel and/or obstacle detection device, that can be mechanical or electronic.

Advantageously, the electric motor 16, the brake 29 and the reducer 19 are mounted inside the casing 17 of the electromechanical actuator 11.

The winding tube 4 is driven in rotation about the axis of rotation X and of the casing 17 of the electromechanical actuator 11 by being supported via two pivot links. The first pivot link is produced at a first end of the winding tube 4 by means of a crown ring 30 inserted around a first end 17a of the casing 17 of the electromechanical actuator 11. The crown ring 30 thus makes it possible to produce a bearing. The second pivot link, not represented in FIG. 4, is produced at a second end of the winding tube 4, not visible in this figure.

Advantageously, the electromechanical actuator 11 comprises a torque support 21. The torque support 21 protrudes at the first end 17a of the casing 17 of the electromechanical actuator 11, in particular the end 17a of the casing 17 receiving the crown ring 30. The torque support 21 of the electromechanical actuator 11 thus makes it possible to fix the electromechanical actuator 11 onto a frame 23, in particular a flange of the box 9.

Furthermore, the torque support 21 of the electromechanical actuator 11 can make it possible to shut the first end 17a of the casing 17.

Moreover, the torque support 21 of the electromechanical actuator 11 can make it possible to support the electronic control unit 15. The electronic control unit 15 can be supplied with electrical energy by means of the electrical power supply cable 18.

Here, and as illustrated in FIG. 4, the electronic control unit 15 is thus disposed, in other words incorporated, inside the casing 17 of the electromechanical actuator 11.

As a variant, not represented, the electronic control unit 15 is disposed outside of the casing 17 of the electromechanical actuator 11 and, in particular, mounted on the frame 23 or in the torque support 21.

Advantageously, the output shaft 20 of the electromechanical actuator 11 is disposed inside the winding tube 4 and at least partly outside the casing 17 of the electromechanical actuator 11.

Advantageously, one end of the output shaft 20 protrudes with respect to the casing 17 of the electromechanical actuator 11, in particular with respect to a second end 17b of the casing 17 opposite the first end 17a.

Advantageously, the output shaft 20 of the electromechanical actuator 11 is configured to drive a link element 22 linked to the winding tube 4 in rotation. The link element 22 is produced in the form of a wheel.

When the electromechanical actuator 11 is started up, the electric motor 16 and the reducer 19 drive the output shaft 20 in rotation. Furthermore, the output shaft 20 of the electromechanical actuator 11 drives the winding tube 4 in rotation via the link element 22.

Thus, the winding tube 4 drives the screen 2 of the privacy device 3 in rotation, so as to open or close the opening 1.

There now follows a description, with reference to FIGS. 5 to 7, of a mode of execution of a method for determining at least one parameter of a closure, privacy or solar protection installation 100 according to the invention and represented in FIGS. 1 to 4.

Preferably, the method is implemented by means of a mobile terminal 33.

Here, the mobile terminal 33 can be the local control unit 12 and comprise all or part of the elements of which the latter is composed.

Preferentially, the mobile terminal 33 is a smart phone.

As a variant, the mobile terminal 33 can be a touch tablet, a laptop computer, a configuration tool or any type of computer.

The mobile terminal 33 can be any mobile device configured to implement the method that is the subject of the invention.

The mobile terminal 33 preferably comprises at least the controller 35, a photographic appliance 37 and an orientation detection device 38.

Advantageously, the photographic appliance 37 of the mobile terminal 33 is a camera.

Advantageously, the photographic appliance 37 of the mobile terminal 33 comprises an image sensor, not represented.

Advantageously, the image sensor of the photographic appliance 37 of the mobile terminal 33 is a CCD (acronym for “Charge Coupled Device”) sensor. In addition, the image sensor of the photographic appliance 37 of the mobile terminal 33 is configured to transform light signals into electrical signals.

Advantageously, the orientation detection device 38 of the mobile terminal 33 comprises a gyroscope.

As a variant, the orientation detection device 38 of the mobile terminal 33 comprises a magnetometer, that can be combined with an accelerometer and/or with a gyroscope.

Advantageously, the mobile terminal 33 comprises, in addition, a satellite positioning device 39.

Here, the mobile terminal 33 comprises the second communication module 36, as described previously with reference to the local control unit 12, like the selection 14 and display 34 elements.

Advantageously, a method according to the invention is implemented by an application of the mobile terminal 33 or configuration tool. Alternatively, the implementation of the method can be distributed in several computers, that is to say that certain steps of the method according to the invention can be executed by a first computer and some other steps can be executed by at least one other computer. Notably, the executions of the steps of the method that is the subject of the invention can be distributed in any combination of one or more of the following computers:
the mobile terminal 33,
the local control unit 12,
the central control unit 13, and
the remote server 28.

In such a case of distributed execution, step execution or processing results are transmitted from one computer to another. The computer or computers involved in the execution of the method that is the subject of the invention is or are configured to implement all the steps of the method for which they are responsible or comprise all the software and/or hardware means for implementing the steps of the method for which they are responsible.

The determination method is preferably implemented while the installation 100 is considered as a project for a given site, but not yet constructed or installed on site. Thus, the different steps described below can be implemented on the basis of a virtual definition of the installation. Nevertheless, the determination method can also be implemented on the basis of a definition of an installation constructed and installed on site. The determination method can also be implemented on the basis of an installation of which a part is constructed and installed on site, another part being only envisaged as a project.

One mode of execution of the determination method comprises the steps which are described hereinbelow with reference to FIG. 5.

In a first step E10, a first set E1 of adaptative parameters for defining the installation is obtained. This obtaining is notably made possible by the action of a user or of an installer or of a designer by an input of a set of parameters of the installation that he or she deems acceptable given the situation of the installation, that is say given the manner in which the installation is or should be constructed. This input is advantageously done on the mobile terminal, for example via its touch screen. The nature of the parameters obtained can be extremely varied. Notably, the parameters can comprise:
a type of privacy or solar protection product or a type of screen,
a length of the screen,
a width of the screen,
an orientation of the screen relative to a vertical (angle α),
a length of projection, in a vertical direction, of the screen onto a horizontal surface,
a valance height,
a position or location of the installation relative to the structure of the building,
a pergola or arbour height,
an orientation of the screen relative to the cardinal points in the case of the pergola or the arbour.

In particular, at least one parameter is a parameter associated with the geometry of the screen in the installation.

Other additional parameters can be of yet another nature. For example, one parameter can be an opacity of the screen with respect to the solar radiation or a material to constitute the screen. The initial values input or obtained of the parameters can correspond to values which seem a priori suitable for the user. Parameters can be composed of several parameters, for example a screen length and width. One of the parameters of the first set can be a parameter defining a state or a configuration of the installation. For example, one of the parameters of the first set can be a degree of deployment or unwinding of the screen at a given instant, notably at the instant when the method is implemented.

The parameters of the installation are adaptable inasmuch as their values can be defined when designing, when choosing or when mounting the installation.

The first set comprises at least one parameter associated with the geometry of the screen in the installation. Preferably, it comprises one, two or a few parameters.

In other words, the first set is the set of the parameters on the value of which it is possible to act in order to optimize the planned installation, in particular from the viewpoint of the shadow created by the screen of the installation and its geometrical characteristics, for example its extent when the latter is at least partly deployed. Such a shadow, and in particular its geometrical characteristics, has an impact on the functionalities (in particular on the thermal and/or visual comfort in the building) and on the energy consumption of the building. The geometrical characteristics of the shadow created by the screen of the installation are notably dependent on the at least one parameter associated with the geometry of the screen in the installation.

In a second step E20, a second set E2 of parameters defining the installation is obtained. This second set comprises parameters which are fixed or immutable or considered as such, notably in light of the environment of the installation. These parameters are parameters that complement the first set E1. The totality of the parameters of the first set and of the second set makes it possible to fully define the installation or its state or its configuration. The totality of the parameters of the first set and of the second set makes it possible to calculate geometrical characteristics, notably an extent of the shadow produced by the installation in its state or its configuration defined for at least one position of deployment of the screen, as explained below. Notably, the second set includes:
the location of the installation,
the latitude of the site of the installation,
the longitude of the site of the installation,
the orientation of the installation or of the screen or of the facade of a building on which or near which the installation is mounted or has to be mounted,
dimensional parameters of an existing structure, notably a building, such as, for example, a glazing surface area of a window of the building near to which the installation is mounted or has to be mounted.

Generally, the second set comprises any determining parameter for defining a shadow created by the screen of the installation and on which it is not possible to act, notably any parameter which cannot be set.

The second set also comprises any parameter that is a priori adaptable (notably any parameter mentioned previously as potentially forming part of the first set), but the value of which is fixed arbitrarily, by choice or by constraint. For example, some of the following parameters can form part of the second set:
a type of privacy or solar protection product or a type of screen because the user has chosen such a type,
a length of the screen because the user has chosen such a length, for example for a financial reason,
a width of the screen because the user has chosen such a length in the case of an awning blind for an aesthetic reason associated with the building on which it has to be mounted or a width of the screen associated with the dimensions of a glazing of a window of the building with which the screen is associated,
a valance height chosen by the user for an aesthetic reason,
a position or location of the installation relative to the structure of the building chosen by the user for an aesthetic reason.

These parameters of the second set can be obtained following an input by the user or the installer or the designer. This input is advantageously done on the mobile terminal, for example via its touch screen. Regarding the ways the orientation of the screen are obtained, they can be performed automatically by using means incorporated in the mobile terminal, for example a compass. Notably to obtain the screen orientation of the installation, the screen of the mobile terminal can be positioned:
parallel to the screen 2 of the installation in its deployed position in the real installation on site, or,
on site, parallel to the screen that the installation should have after mounting and configuration.

A validation action on the mobile terminal makes it possible to save the orientations with respect to the vertical and with respect to the cardinal points. These orientation values are obtained by measuring the orientation of the mobile terminal using its orientation detection device 38.

In this step E20, location coordinates of the installation, notably a longitude and a latitude, are also obtained, as explained previously. These coordinates can be input by the user or the installer or the designer. This input is advantageously done on the mobile terminal, for example via its touch screen. The obtaining can advantageously be performed automatically by using means incorporated in the mobile terminal, for example a Global Positioning System with the acronym GPS. Notably to obtain location coordinates of the screen of the installation, the mobile terminal on site can be positioned at the point where the installation is located or at the point where the installation is planned to be located. A validation action on the mobile terminal makes it possible to save the location of the installation in a terrestrial reference frame. The location coordinates are preferably obtained by measuring the location of the mobile terminal using its satellite positioning device 39.

All the parameters of the first and second sets make it possible to fully define the position of the screen 2, notably in a geocentric frame of reference.

In a third step E30, a timestamp is obtained. This timestamp can be input by the user or the installer or the designer. This input is advantageously done on the mobile terminal, for example via its touch screen. The timestamp can alternatively be obtained automatically, for example by obtaining the date and the time at the moment of implementation of the method. Thus, the timestamp datum includes the identification of a day and of a given instant in this day using a time. The aim here is indeed to determine the position of the sun in the sky at the instant corresponding to the timestamp.

Optionally, but preferentially, in a fourth step E50, a solar mask M is obtained at the location of the installation or at the planned location of the installation. The solar mask M is produced by several obstacles disposed more or less close to the installation and likely to provoke a shadow thereon, at given instants, in particular in the course of a year. This or these obstacles can be, for example:
a building, notably a house or an apartment block,
vegetation, notably a bush or a tree,
a relief of the landscape around the building 100, notably a mountain,
generally, the environment of the installation.

These solar mask data can form part of the second set.

In a first substep E51, the mobile terminal 33 is positioned at the point where the installation 100 is located or at the point where the installation 100 is planned.

In this way, the location of the installation corresponds to the location from which the solar mask M is determined.

Following the substep E51, a photograph or several photographs P is or are taken by means of the photographic appliance 37 of the mobile terminal 33 in a substep E52. Data defining this photograph or these photographs P, taken in the step E52, are stored in a memory of the controller 35 of the mobile terminal 33.

In a substep E53, the orientation of the photographic appliance 37 of the mobile terminal 33 in the substep E52 of taking photographs P is determined by means of the orientation detection device 38 and of the controller 35 of the mobile terminal 33. Thus, this step E50 of obtaining the solar mask comprises a step of producing at least one photographic image from the location of the installation and in a known direction. The photograph or photographs is or are again processed digitally, for example by brightness threshold detection to discriminate the sky from obstacles. FIG. 6 represents an example of such a photograph P after processing, the black zones representing the obstacles. Thus, this step E50 comprises a step of processing the at least one photographic image.

The step E50 further comprises a substep E54 of superimposition of data of the processed photograph with a solar path diagram S, in a common reference frame R, V, so as to determine the solar mask M at the predetermined location of the installation 100. The solar path diagram can be calculated on the mobile terminal or can be imported or downloaded, notably from the server 28.

The solar path diagram S, also called solar diagram, is a diagram indicating, at different instants of the year, an angular height, also called elevation or angle height, of the sun and an azimuth of the direction of the sun for a given latitude. The solar path diagram S thus makes it possible to define a trajectory of the sun perceived at the predetermined location of the installation for different instants, in the course of the year. In this way, the solar path diagram S makes it possible to define instants during which an incident direct solar radiation exists at the predetermined location of the installation, in particular in weather conditions in which the sky is clear and there are no other obstacles to the solar radiation.

The solar path diagram S illustrated in FIG. 7 is an example of graphic representation for a given latitude and longitude. Each curve represents an apparent course of the sun as a function of the time for a determined date of the year.

The solar mask M is thus a representation of elements projecting, in the direction defined by abscessae and ordinates, a shadow at the predetermined location of the installation 100.

Moreover, the superimposition of the data of the photograph P, corresponding to the result of the substep E52, with the solar path diagram S, in the common reference frame R, V, makes it possible to determine, at each instant, in particular in the course of the year, if the sun is visible or not at the predetermined location of the installation.

Here, the application of the mobile terminal 33 makes it possible to determine the solar mask M for the installation 100.

In order to implement the superimposition step E54, the data of the photograph P and the data of the path diagram S are expressed in the same reference frame, in other words in the common reference frame R, V. Thus, this step E50 comprises a step of processing the at least one photographic image.

Such a common reference frame can be, notably, a cardinal reference frame R, a three-dimensional reference frame centred on a mid-point of the image sensor of the photographic appliance 37 of the mobile terminal 33, a three-dimensional reference frame centred on a focal point of the lens of the photographic appliance 37 of the mobile terminal 33 or a spherical sky reference frame, also called projection reference frame V.

Alternatively or in addition to the substeps E51 to E53, in a substep E51′, an image or solar mask data due to the geographical or geological relief can be retrieved by downloading only from an external database, notably by downloading from the server 28.

In a fifth step E60, a shadow produced by the installation, notably by the screen 2 of the installation at the moment given by the timestamp when the screen is in a given position, in particular in a totally deployed position, is calculated. This calculation is preferably performed on the mobile terminal 33. In particular, the geometrical characteristics of the shadow produced by the screen of the installation at at least one moment given by a timestamp are calculated, the screen being considered in a position of at least partial deployment, on the basis of the at least one parameter of the first set associated with the geometry of the screen in the installation. For this, the mathematical projection, according to the direction of the sun at the moment given by the timestamp, of the screen on the surrounding surfaces, notably on the ground and possibly on the structure of the building, is calculated. Characteristics of shadows projected onto horizontal surfaces like the ground and/or onto vertical surfaces like the walls of the building are thus obtained. As a consequence of the nature of this calculation, to perform it, the following are used:
the values of the parameters of the first set E1, including at least one parameter associated with the geometry of the screen in the installation, and
the values of the parameters of the second set E2.

Indeed, these values are values that have an influence, with the date and the time (timestamp), on the characteristics of the calculated shadow, in particular on the geometrical characteristics of the calculated shadow.

In a sixth step E70, with all the values of the parameters collected previously, the calculated shadow is displayed on an image, preferably in augmented reality. The image can be a photograph of the site receiving the installation or intended to receive the installation, this photograph being taken at a past instant. Alternatively, the image can be an instantaneous image of a video stream displayed on the screen of the mobile terminal 33 while the camera of the mobile terminal points toward the site receiving the installation or intended to receive the installation. In the different cases, this image is processed and modified to show a representation of the shadow calculated in the preceding step.

Several alternative or complementary representations of the shadow can be used. For example, it is possible to shade or reduce the intensity or the contrast of the zones 304 of the image corresponding to surfaces of the site located in the calculated shadow or to the shadow of the screen according to the calculation of the step E60. Alternatively or in addition, it is possible to show on the image lines or curves 305 representing the boundaries on surfaces between zones located in the calculated shadow and zones located outside of the calculated shadow. Such representations on an image are illustrated in FIG. 3.

In addition, as illustrated in FIG. 3, it is possible to show on the image a representation of the installation 100, even if the latter is not installed on the site. Likewise, it is possible to show on the image any other element making it possible to better envisage the effect of the installation on the site. For example, it is possible to show people or furniture elements (like a table and/or chairs and/or armchairs). Advantageously, if the installation provided comprises a photovoltaic panel, a virtual representation of the photovoltaic panel is incorporated in the representation. Likewise, in such a case, the radiation energies received by the photovoltaic panel and the electrical energies produced as a consequence by such a panel are determined.

By virtue of this step, a view or image of the site envisaged to locate the installation can be complemented with a virtual representation of a shadow produced by a given installation at a given instant. Advantageously too, the view or image of the site envisaged to locate the installation can be complemented with a virtual representation of the installation and/or a virtual representation of other elements (people, furniture). It should be noted that the representation of people and/or of elements on the image may not be virtual, but correspond to representations of people and/or of elements genuinely located on the site when photographed.

If the shadow created by the screen of the installation suits the user (possibly after several iterations of the method), the value or the values of the parameters of the first set considered to perform the calculations of the last step E60 can be retained. The method can then be terminated.

The user can assess whether the shadow is suitable through the observation of a representation, notably of a dynamic representation, of the shading obtained in the step E70. Thus, the calculated shadow is used to define the value of at least one first parameter of the first set. Thus too, it is possible to determine a value or several values of parameters by the implementation of the method.

Thus, in the step E70, the calculated shadow is used to define or redefine the value of at least one first parameter of the first set, in particular at least one first parameter associated with the geometry of the screen in the installation.

Once the value of at least one first parameter has been defined or redefined, this value is memorized.

In addition or alternatively, in this step E70, a solar radiation power intercepted by the installation producing the shadow is calculated. As a consequence of this calculation, the solar radiation power which is not transmitted to the building and therefore the cooling power of the building which can be saved are calculated. For this, in a step of obtaining data, it is necessary to transmit thermal characteristics of the building, notably thermal characteristics of the walls of the building and/or thermal characteristics of the openings of the building (windows, doors, glazed frames).

This power information can be displayed on the mobile terminal 33.

However, if the shadow created by the screen of the installation does not suit the user, the method goes on to a seventh step E80.

In the seventh step E80, a characteristic of the calculated shadow is modified, notably by action on the mobile terminal, to define a modified shadow extent. A modified shadow characteristic is understood to be a characteristic specific to a shadow zone defined by the method according to the invention, notably a geometrical characteristic. For example, this modification can be made directly on the touch screen of the mobile terminal 33 displaying a calculated shadow as image, by pointing to a zone of the image showing the calculated shadow and by indicating that this zone should not be located in the shadow if it is located therein on the image or that this zone should be located in the shadow if it is not located therein on the image, that is to say that the status of the zone being pointed to relating to the calculated shadow is modified. Alternatively, a modification can be made by acting on a line or a curve representing on an image a boundary of the shadow. For example, the same tools as those used to stretch a shape on drawing software can be used.

Once the characteristic of the shadow, notably its extent, has been modified, in a ninth step E90, the value or values of the parameters of the first set used to perform the calculations of the last step E60 executed is or are modified or one or more new values of the parameters of the first set which could be necessary to obtain the modified shadow which appears more suited to the user is or are calculated. This modification is made directly by the mobile terminal. Once the modification or modifications have been performed, there is a loop to the step E60 in which the calculations are performed with the new values of the parameters. If need be, several iterations of the steps E90 and E60 can be performed before the mobile terminal determines whether the modification or modifications lead to a result sufficiently approximating the wishes of the user and whether this result can be presented to him or her in a step E70 or before the user validates the result presented.

Thus, one or more successive iterations of a step of modifying a value of the at least one first parameter of the first set of parameters and of the step E60 are implemented.

Advantageously, several values of the first parameter are memorized after different iterations of the steps. Thus, the method can further comprise a subsequent step of choosing a value from among the several values memorized. The choice of value of the parameter or parameters of the first set can be made by simple visualization or maximization of the shadow or maximization of the duration for a given minimum shadow or a combination of these elements. Alternatively, the choice can be made arbitrarily by the user.

Through the implementation of these steps, a user or an installer or a designer can determine the value of the parameter or parameters of the first set in order to optimize the shadow created by the screen of the installation. In addition, he or she can assess over a given period the shadow produced and/or the cooling thermal power of the building which can be saved with these determined parameter values making it possible to complete a definition of the installation.

Complementing what has been described previously, in the step E90, a value of at least one second parameter of the first set of parameters, different from the first parameter, is also modified. In such a case, the method simultaneously or successively optimizes the values of two parameters of the first set so as to define an installation suited to the wishes of the user.

Thus, by successive iterations of implementations of the preceding steps, it is possible to optimize one or more values of parameters of a home automation installation. Through the implementation of the method, values of parameters such as in particular:
a length of the screen,
a width of the screen,
an orientation of the screen relative to a vertical (angle α),
a length of projection, in a vertical direction, of the screen on a horizontal surface,
a valance height,
a position or location of the installation relative to the structure of the building,
a pergola or arbour height,
an orientation of the screen relative to the cardinal points in the case of the pergola or of the arbour,
can be optimized iteratively, that this to say by implementing steps of the method several times.

Preferably, the order of execution of the steps E10 to E50 is immaterial.

One mode of execution of a method for configuring the installation 100 is described hereinbelow.

This mode of execution comprises:
a phase of implementing the determination method described previously, and
a phase of taking into account at least one parameter determined in the preceding phase.

Notably, the phase of taking into account can be:
a phase of producing the installation in accordance with the at least one parameter determined in the preceding phase, and/or
a phase of configuring the installation in accordance with the at least one parameter determined in the preceding phase, and/or
a phase of saving, in a control unit 12, 13, the at least one parameter determined in the preceding phase, and/or
a phase of creating a control command dependent on the at least one parameter determined in the preceding phase.

An example of production of the installation in accordance with the at least one parameter determined in the preceding phase can be as follows. During the phase of implementation of the determination method, it has been seen previously that, notably, the following parameters can be determined:
a length of the screen,
a width of the screen,
an orientation of the screen relative to a vertical (angle α),
a length of projection, in a vertical direction, of the screen on a horizontal surface,
a valance height,
a pergola or arbour height.

These various parameters directly influence the production of the installation. Indeed, these parameters are or can be parameters which will be fixed during the production of the installation. Such is particularly the case with the length of the screen or the presence of a valance for example. Moreover, the definition of these parameters can have indirect consequences on the production of the installation. For example, the length and the width of the screen influence the dimensions of the winding tube 4, the dimensions of the box 9 or even the type of the actuator 11 used.

An example of configuration of the installation in accordance with the at least one parameter determined in the preceding phase can be as follows. In the phase of implementation of the determination method, it has been seen previously that, notably, the following parameters can be determined:
an orientation of the screen relative to a vertical (angle α),
a position or location of the installation relative to the structure of the building,
an orientation of the screen relative to the cardinal points in the case of the pergola or of the arbour.

These various parameters directly influence the configuration of the installation. Indeed, these parameters are or can be parameters which will be fixed during installation on site. This is particularly the case with the orientation of the screen relative to a vertical (angle α) for example.

An example of phase of saving, in a control unit 12, 13, values of parameters of the first set determined in the preceding phase can be as follows. During the phase of implementation of the determination method, it has been seen previously that many parameters have been input and/or determined. All these parameters constitute important data for controlling the installation. The data concerning the environment of the installation, notably the solar mask data, are also important data for controlling the installation. Thus, these parameters can advantageously be known to the control units of the installation. Consequently, once the definition of the installation has been completely set or stopped, these parameters are advantageously transmitted to the control units by the mobile terminal 33. Some of these parameters will advantageously be used to define control commands of the installation, notably define commands for automatic deployment and/or folding up of the screen, possibly associated with the weather situation. For example, all these parameters will be able to be used to define a screen deployment command that changes over time which makes it possible to ensure that a part of a terrace remains in shadow between certain times of the day during a summer season. Such a command makes it possible to drive the automatic deployment of the blind to ensure this function.

One mode of execution of the method also makes it possible to determine a thermal energy saved in the building during a given time period.

In this mode of execution, a start-of-period timestamp T0, an end-of-period timestamp T1 and a time interval dt making it possible to break down the period into N elementary periods are chosen. Once the characteristics of the installation 100 have been defined, iterations of the step E60 described above are then implemented by considering the timestamp of each elementary period i. A saved thermal power Pe(i) associated with each elementary period is thus obtained. The thermal power saved per elementary period is notably obtained by a percentage of the thermal power linked to the theoretical insolation on a part of the building shaded by the screen. The percentage can be a predefined percentage, for example between 40 and 60% representing an average percentage of energy associated with the insolation contributing to heating up the building or a percentage calculated from parameters of the first or second set, in particular from parameters making it possible to define the share of the energy associated with the insolation and which would be transmitted to heat up the building. The saved energy is finally obtained by taking all or part of the sum over all of the elementary periods of the product Pe(i)×dt. For this implementation, in the step E60, the geometrical characteristics of the shadow projected onto the walls and the openings of the building are considered to calculate the saved energy (that is to say the energy which would have had to be consumed to cool the building and obtain the same thermal comfort in the building in the absence of the installation). Moreover, this implementation demands the installation to be fully defined. Thus, this implementation of the energy-saving determination method requires the method for determining a parameter value of the first set to have been previously implemented, in order for the installation to be fully defined as desired by the user. Consequently, in the preceding energy calculations, the nature of the blind fabric can for example be taken into account also because it impacts the proportion of the thermal radiation transmitted through the screen.

For greater accuracy in the estimation of saved thermal energy, the mode of execution can be based on radiation histories (for example from weather databases) specific to the location of the building and to its orientation.

In the various embodiments described, when the screen comprises slats, the different simulations are performed preferably by considering the slats in a configuration that completely blocks or blocks to the maximum the light rays. Alternatively or in addition, simulations can however also be performed by considering the slats in configurations partially blocking the light rays. These configurations will be able to be defined by an angle of orientation of the slats.

The embodiments and variants envisaged can be combined to generate new embodiments of the invention, without departing from the scope of the invention.

Throughout this document, “timestamp” is understood to mean any definition of a set of data comprising a time and a date. The timestamp can relate to a current instant or any instant in the past or in the future. The timestamp can be produced automatically or by data input by a user, an installer or a designer.

By virtue of the solutions described previously, it is possible to determine at least one parameter of a closure, privacy or solar protection installation in order to optimize a home automation installation in terms of functionalities provided to the users. An optimized functionality can relate to:
the comfort, notably the thermal comfort or the visual comfort, by optimization of the shadow, and/or
the costs and consumptions of energy, notably of heating and/or air conditioning energy, by optimization of the shadow, and/or
the use of an approach to the building, notably a terrace or a balcony, by optimization of the shadow, notably by ensuring a shadow at the moments of occupancy of the approach.

Typically, this optimization can be performed by choosing a screen geometry which makes it possible to produce a shadow that is optimized for the envisaged use of the building and its approaches.

1. A method for determining at least one parameter of an installation comprising a closure, privacy or solar protection screen, the method being at least partially implemented by a configuration tool of the installation, the method comprising:
obtaining a first set of adaptative parameters for defining the installation, including at least one parameter associated with a geometry of the screen in the installation,
obtaining a second set of fixed parameters defining the installation,
calculating a shadow produced by the screen of the installation at at least one moment given by a timestamp, the screen being considered in a position of at least partial deployment,
using the calculated shadow in defining a value of at least one first parameter of the first set of adaptive parameters.

2. The determination method as claimed in claim 1, wherein the method further comprises:
memorizing the value of the at least one first parameter of the first set of adaptive parameters, and
one or more successive iterations of (i) modifying the value of the at least one first parameter of the first set of adaptive parameters and of (ii) carrying out the calculating a shadow produced by the screen of the installation at at least one moment given by a timestamp, the screen being considered in a position of at least partial deployment.

3. The determination method as claimed in claim 1, wherein the method further comprises:
memorizing the value of the at least one first parameter of the first set of adaptive parameters, and
one or more successive iterations of (i) modifying a value of at least one second parameter of the first set of adaptive parameters, different from the first parameter, and of (ii) carrying out the calculating a shadow produced by the screen of the installation at at least one moment given by a timestamp, the screen being considered in a position of at least partial deployment.

4. The determination method as claimed in claim 1, wherein the method further comprises:
modifying a characteristic of the shadow calculated in the using of the calculated shadow in defining a value of at least one first parameter of the first set of adaptive parameters, and as a consequence of the modifying,
determining a modified value of the at least one first parameter.

5. The determination method as claimed in claim 4, wherein the modifying of the calculated shadow characteristic comprises:
displaying the calculated shadow as image on an interface of the configuration tool,
pointing to a zone on the image displaying the shadow, and
modifying a status of the shadow in the zone being pointed to.

6. The determination method as claimed in claim 1, wherein the installation is a motorized installation and wherein the method comprises transmitting from the configuration tool to a control unit of the installation:
the first set of adaptative parameters for defining the installation, and/or
the second set of fixed parameters for defining the installation, and/or
the value of the at least one first parameter defined during the using of the calculated shadow.

7. The determination method as claimed in claim 1, wherein the method further comprises obtaining a solar mask at a location of the installation, the obtaining of the solar mask comprising:
producing at least one photographic image from the location and in a known direction, and
processing the at least one photographic image.

8. The determination method as claimed in wherein the method further comprises:
iterations of the carrying out of calculating a shadow produced by the screen of the installation at at least one moment given by a timestamp, the screen being considered in a position of at least partial deployment, for different timestamps, and
calculating a radiation energy intercepted by the screen of the installation during a period defined by the different timestamps.

9. A method for configuring a home automation installation, comprising:
implementing the determination method as claimed in claim 1, and
producing and/or configuring the installation in accordance with the value of the at least one first parameter of the first set of adaptive parameters.

10. The configuration method as claimed in claim 1, wherein the method further comprises creating a control command dependent on the value of the at least one parameter defined in the using of the calculated shadow in defining a value of at least one first parameter of the first set of adaptive parameters.

11. An installation or control unit obtained by the implementation of the method as claimed in claim 9.

12. The determination method as claimed in claim 2, wherein the method further comprises choosing from among several values of the at least one first parameter of the first set of adaptive parameters.

13. The determination method as claimed in claim 4, wherein the determining of the modified value of the at least one first parameter makes it possible to obtain the modified characteristic of the shadow.

14. The determination method as claimed in claim 2, wherein the method further comprises:
memorizing the value of the at least one first parameter of the first set of adaptive parameters, and
one or more successive iterations of (i) modifying a value of at least one second parameter of the first set of adaptive parameters, different from the first parameter, and of (ii) carrying out the calculating a shadow produced by the screen of the installation at at least one moment given by a timestamp, the screen being considered in a position of at least partial deployment.

15. The determination method as claimed in claim 2, wherein the method further comprises:
modifying a characteristic of the shadow calculated in the using of the calculated shadow in defining a value of at least one first parameter of the first set of adaptive parameters, and as a consequence of the modifying,
determining a modified value of the at least one first parameter.

16. The determination method as claimed in claim 15, wherein the modifying of the calculated shadow characteristic comprises:
displaying the calculated shadow as image on an interface of the configuration tool,
pointing to a zone on the image displaying the shadow, and
modifying a status of the shadow in the zone being pointed to.

17. The determination method as claimed in claim 15, wherein the determining of the modified value of the at least one first parameter makes it possible to obtain the modified characteristic of the shadow.

18. The determination method as claimed in claim 3, wherein the method further comprises:
modifying a characteristic of the shadow calculated in the using of the calculated shadow in defining a value of at least one first parameter of the first set of adaptive parameters, and as a consequence of the modifying,
determining a modified value of the at least one first parameter.

19. The determination method as claimed in claim 18, wherein the modifying of the calculated shadow characteristic comprises:
displaying the calculated shadow as image on an interface of the configuration tool,
pointing to a zone on the image displaying the shadow, and
modifying a status of the shadow in the zone being pointed to.

20. The determination method as claimed in claim 18, wherein the determining of the modified value of the at least one first parameter makes it possible to obtain the modified characteristic of the shadow.
